(19) United States
(12) Patent Application Publication
(10) Pub. No.: US 2010/0210168 A1
(43) Pub. Date: Aug. 19, 2010

(54) PLASMA DISPLAY PANEL MANUFACTURING METHOD

(76) Inventors: Koyo Sakamoto, Osaka (JP); Shinichiro Ishino, Osaka (JP); Kaname Mizokami, Kyoto (JP); Yuichiro Miyamae, Osaka (JP); Yoshinao Ooe, Kyoto (JP)

Correspondence Address: WENDEROTH, LIND & PONACK L.L.P., 1030 15th Street, N.W., Suite 400 East, Washington, DC, 20005-1503, US

(21) Appl. No.: 12/678,837

(22) PCT Filed: Jun. 12, 2009
(86) PCT No.: PCT/JP2009/002663

§ 371 Date: Mar. 18, 2010

(30) Foreign Application Priority Data
Jun. 30, 2008 (JP) 2008-170073

(51) Int. Cl. H01J 9/00

(52) U.S. Cl. 445/24

(57) ABSTRACT

In order to realize a plasma display panel with high-definition/high-luminance display performance as well as with low power consumption, after formation of a primary film, a metal oxide paste made up of metal oxide particles, an organic resin component, and diluting solvent is applied and fired. Thereby, a plurality of aggregated particles of the metal oxide particles are attached and formed onto the primary film. As the metal oxide paste used is one with a content of the aggregated particles of the metal oxide particles being not larger than 1.5 vol % and a content of the organic resin component being in a range of 8.0 vol % to 20.0 vol %.

### TECHNICAL FIELD

The present invention relates to a method for manufacturing a plasma display panel.

### BACKGROUND ART

Among flat panel displays (FPDs), a plasma display panel (hereinafter referred to as a PDP) is capable of performing a high-speed display and easy to increase in size, thus having been in widespread commercial use in fields of a video display device, a publicity display device, and the like.

A typical AC-driven surface discharge type PDP adopts a triode structure, being a structure in which two glass substrates, a front panel and a rear panel, are opposed to each other with a predetermined spacing therebetween. The front panel is configured of: display electrodes made up of striped scan electrodes and sustain electrodes formed on a glass substrate; a dielectric layer covering the display electrodes and working as a capacitor for accumulating electric charges; and a protective film having a thickness of the order of 1 μm and formed on the dielectric layer. Meanwhile, the rear panel is configured of: a plurality of address electrodes formed on a glass substrate; a primary dielectric layer covering the address electrodes; barrier ribs formed thereon; and phosphor layers applied inside display cells, formed by the barrier ribs, for emitting lights in red, green and blue respectively.

The front panel and the rear panel are sealed in an airtight manner with electrode-formed surface sides thereof opposed to each other, and a discharge space partitioned by the barrier ribs is filled with discharge gas of Neon (Ne) and Xenon (Xe) at a pressure of 53 kPa to 80.0 kPa. The PDP realizes a colored image display in such a manner that video signal voltages are selectively applied to the display electrodes for discharging, and ultra-violet rays generated by the discharging excite the phosphor layers of the respective colors for emission of lights in red, green, and blue (see Patent Document 1).

In such a PDP, the protective layer formed on the dielectric layer of the front panel has functions including protection of the dielectric layer from ion impact caused by the discharge and emission of primary electrons for generating address discharge. The protection of the dielectric layer from ion impact is an important function for preventing a rise of a discharge voltage, and the emission of primary electrons for generating the address discharge is an important function for preventing an erroneous address discharge that cause flickers on images.

For the purpose of increasing the number of primary electrons emitted from the protective layer to reduce flickers on images, an attempt has been made such as addition of silicon (Si) or aluminum (Al) to magnesium oxide (MgO).

In recent years, with the progress of high definition in televisions, there has been a demand in market for a full HD (high-definition, 1920×1080 pixels, progressive display) PDP at lower cost with lower power consumption and higher luminance. Since characteristics of electron emission from the protective layer determine an image quality of a PDP, controlling the electron emission characteristics is a critically important issue.

### CITATION LIST

### PATENT DOCUMENT

[Patent Document 1] Unexamined Japanese Patent Publication No. 2007-48733

### DISCLOSURE OF THE INVENTION

A method for manufacturing a PDP in accordance with the present invention is a method for manufacturing a PDP having a front panel which is formed with a dielectric layer so as to cover a display electrode formed on a substrate and is formed with a protective layer on the dielectric layer, and

a rear panel which is opposed to the front panel so as to form a discharge space and is formed with an address electrode in a direction intersecting with the display electrode as well as being provided with a barrier rib partitioning the discharge space, the method including a step of forming a protective layer, which forms the protective layer of the front panel, wherein the step of forming a protective layer includes: a step of forming a primary film, which deposits and forms a primary film on the dielectric layer; and a step of forming aggregated particles of metal oxide particles, which applies to the primary film a metal oxide paste containing aggregated particles of metal oxide particles, an organic resin component, and diluting solvent, and then fires the metal oxide paste, to attach a plurality of aggregated particles of the metal oxide particles to the primary film, and in the step of forming aggregated particles, a metal oxide paste is used in which a content of the aggregated particles of the metal oxide particles is not larger than 1.5 vol %, the organic resin component contains ethyl cellulose, and a content of the organic resin component is in a range of 8.0 vol % to 20.0 vol %.

According to such a manufacturing method, the metal oxide paste excellent in dispersion, printability, and flammability allows discrete and uniform attachment of the aggregated particles of the metal oxide particles within the surface of the primary film, thereby to uniform a coverage distribution within the surface.

This results in provision of a PDP that improves the electron emission characteristics, while having electric charge retention characteristics, and is capable of achieving both a high image quality and low cost as well as a low voltage, so as to realize a PDP with high-definition/high-luminance display performance as well as with low power consumption.

### BRIEF DESCRIPTION OF THE DRAWINGS

FIG. 1 is a perspective view showing a structure of a PDP in an embodiment of the present invention.

FIG. 2 is a sectional view showing a configuration of a front panel of the PDP.

FIG. 3 is a flowchart showing steps for forming a protective layer of the PDP.

FIG. 4 is a characteristic diagram showing a viscosity value of a metal oxide paste in the embodiment of the present invention.

FIG. 5 is a characteristic diagram showing a relation between a storage period and a viscosity η after preparation of the metal oxide paste in the embodiment of the present invention.

FIG. 6 is a characteristic diagram showing a change in viscosity in a case of adding a viscosity stabilizer to the metal oxide paste in the embodiment of the present invention.

FIG. 7 is a diagram showing a result of a cathode luminescence measurement for aggregated particles.

FIG. 8 is a characteristic diagram showing a result of a study on electron emission performance and a Vscn lighting voltage in the PDP in the embodiment of the present invention.

FIG. 9 is a characteristic diagram showing a relation between a particle diameter of aggregated particles and electron emission characteristics.

FIG. 10 is a characteristic diagram showing a relation between a particle diameter of the aggregated particles and a rate of occurrence of breakage in barrier rib.

FIG. 11 is a diagram showing an example of a particle size distribution of the aggregated particles.

### PREFERRED EMBODIMENTS FOR CARRYING OUT OF THE INVENTION

An embodiment of the present invention is described below with reference to the drawings.

### Embodiment

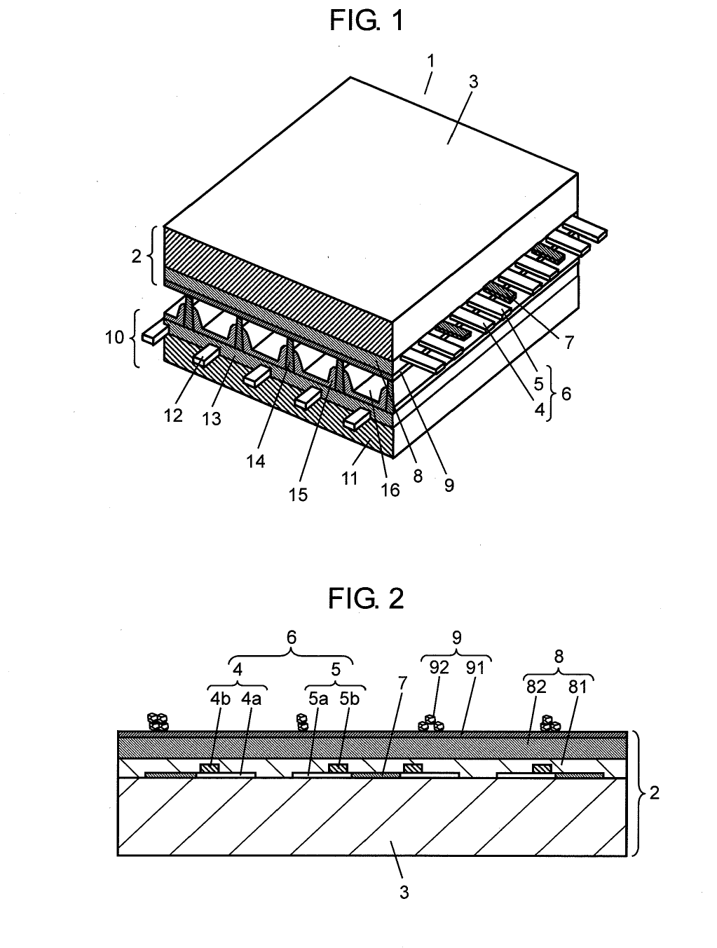

FIG. 1 is a perspective view showing a structure of PDP 1 manufactured with a method for manufacturing a PDP in an embodiment of the present invention. Front panel 2 made up of front glass substrate 3 and the like and rear panel 10 made up of rear glass substrate 11 and the like are opposed to each other, and a peripheral section of those panels is sealed in an airtight manner with a sealing agent made of glass frit or the like. Discharge space 16 inside PDP 1 is filled with discharge gas of Ne, Xe and the like at a pressure of 53.3 kPa to 80.0 kPa. On front glass substrate 3 of front panel 2, a plurality of pairs of belt-like display electrodes 6, each made up of scan electrode 4 and sustain electrode 5, are arranged in parallel with a plurality of black stripes (light proof layers) 7. Dielectric layer 8 that functions as a capacitor is formed on front glass substrate 3 so as to cover display electrodes 6 and light proof layers 7, and further on the surface of dielectric layer 8, protective layer 9 made of magnesium oxide (MgO) or the like is formed.

On rear glass substrate 11 of rear panel 10, multiple belt-like address electrodes 12 are arranged in parallel with one another in a direction intersecting at right angles with scan electrodes 4 and sustain electrodes 5 of front panel 2, and these are covered by primary dielectric layer 13. Further, barrier ribs 14 each having a predetermined height and partitioning discharge space 16 are formed on primary dielectric layer 13 between address electrodes 12. Phosphor layers 15 are formed in grooves between barrier ribs 14. Phosphor layers 15 emit light respectively in red, blue and green with ultraviolet rays. A discharge cell is formed in a position where scan electrode 4 and sustain electrode 5 intersect with address electrode 12, so as to serve as a pixel for colored display.

FIG. 2 is a sectional view showing a configuration of front panel 2 of PDP 1 in the embodiment of the present invention, and FIG. 2 shows a view upside down from FIG. 1. As shown in FIG. 2, black stripe (light proof layer) 7 and display electrodes 6 made up of scan electrode 4 and sustain electrode 5 are patterned on front glass substrate 3 manufactured with a floating method or the like. Scan electrode 4 and sustain electrode 5 are respectively configured of transparent electrodes 4a, 5a made of indium tin oxide (ITO), tin oxide (SnO₂), or the like, and metal bus electrodes 4b, 5b formed on transparent electrodes 4a, 5a. Metal bus electrodes 4b, 5b are used for the purpose of rendering conductivity to longitudinal directions of transparent electrodes 4a, 5a, and are made of a conductive material chiefly made of a silver (Ag) material. Dielectric layer 8 is configured of at least two layers: first dielectric layer 81 provided by covering these transparent electrodes 4a, 5a, metal bus electrodes 4b, 5b, and black stripe (light proof layer) 7 formed on front glass substrate 3; and second dielectric layer 82 formed on first dielectric layer 81. Protective layer 9 is configured of primary film 91 and aggregated particles 92.

Next, a configuration of protective layer 9, as a characteristic of the PDP in the present invention, is described. As shown in FIG. 2, protective layer 9 is configured of primary film 91 and aggregated particles 92. Specifically, first, primary film 91 made of magnesium oxide (MgO) containing aluminum (Al) as an impurity is formed on dielectric layer 8. Further, aggregated particles 92 of magnesium oxide (MgO) crystals as a metal oxide are formed by being discretely dispersed on primary film 91 so as to be distributed almost uniformly over the entire surface. Further, aggregated particles 92 are attached onto primary film 91 so as to be distributed almost uniformly over the entire surface with a coverage being in a range of 2% to 12%.

The coverage in this context is expressed by a ratio of an area “a”, attached with aggregated particles 92, to a discharge cell area “b” in an area of one discharge cell, which is obtained through an expression: coverage (%)=a/b×100. A method for the calculation in the case of actual measurement is, for instance, as follows: an image of an area corresponding to one discharge cell partitioned by barrier ribs 14 is photographed with a camera, and the photographed image after trimmed into dimensions of one cell of x×y is then binarized into data in black and white. Thereafter, based upon the binarized data, the area “a” of a black area due to aggregated particles 92 is calculated, to obtain the coverage through the foregoing expression: a/b×100.

Next, a method for manufacturing the PDP is described. First, as shown in FIG. 2, scan electrodes 4, sustain electrodes 5, and black stripe (light proof layer) 7 are formed on front glass substrate 3. These transparent electrodes 4a, 5a and metal bus electrodes 4b, 5b are formed by being patterned with a photolithography method or the like. Transparent electrodes 4a, 5a are formed using a thin-film process or the like, and metal bus electrodes 4b, 5b are formed by firing and hardening a paste containing a silver (Ag) material at a predetermined temperature. Further, in a similar manner, black stripe (light proof layer) 7 is formed with a method for screen-printing a paste containing a black pigment, or by forming the black pigment on the entire surface of the glass substrate, and then patterning the pigment with the photolithography method for firing.

Subsequently, a dielectric paste is applied with a die-coating method or the like onto front glass substrate 3 so as to cover scan electrodes 4, sustain electrodes 5, and black stripe (light proof layer) 7, thereby forming a dielectric paste layer (dielectric material layer). The dielectric paste layer is then fired and hardened, to form dielectric layer 8 covering scan electrodes 4, sustain electrodes 5, and black stripe (light proof layer) 7. In addition, the dielectric paste is a paint containing binder, solvent, and a dielectric material such as glass powder.

Furthermore, primary film 91 made of magnesium oxide (MgO) containing aluminum (Al) as an impurity is formed on dielectric layer 8 with a vacuum deposition method.

The foregoing steps allow forming predetermined structural elements (scan electrodes 4, sustain electrodes 5, black stripe (light proof layer) 7, dielectric layer 8, primary film 91), except for aggregated particles 92, on front glass substrate 3.

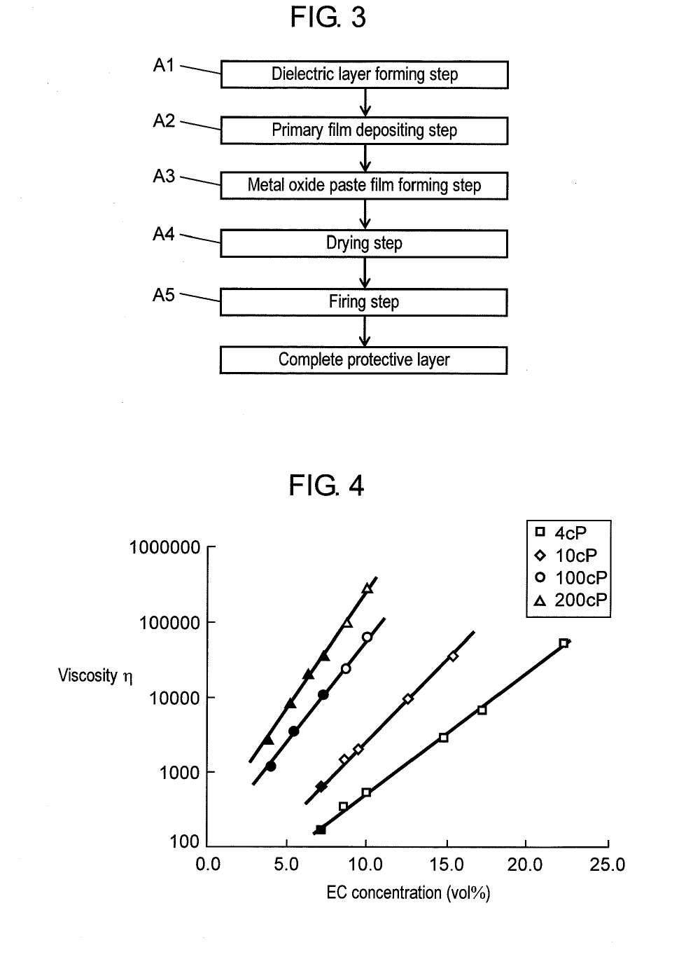

Next, manufacturing steps for forming protective layer 9 of PDP 1 are described with reference to FIG. 3. FIG. 3 is a flowchart showing steps for forming protective layer 9 in the embodiment of the present invention. As shown in FIG. 3, after dielectric layer forming step Al for forming dielectric layer 8 is performed, in a subsequent step of primary film depositing step A2, primary film 91 chiefly made of magnesium oxide (MgO) is formed on dielectric layer 8 with the vacuum deposition method using a sintered body of magnesium oxide (MgO) containing aluminum (Al) as a primary material.

Subsequently, in metal oxide paste film forming step A3, aggregated particles 92, formed by aggregating magnesium oxide (MgO) crystal particles to be the metal oxide particles, are discretely attached and formed onto primary film 91. In this step used is a metal oxide paste obtained by kneading aggregated particles 92 of the magnesium oxide (MgO) crystals with an organic resin component and diluting solvent. This metal oxide paste is applied onto primary film 91 by a screen-printing method or the like, to form a metal oxide paste film.

It is to be noted that the metal oxide paste used in the present invention is detailed later. Further, as a method for forming a metal oxide paste film onto an unfired primary film, other than the screen-printing method, a spraying method, a spin-coating method, a die-coating method, a slit-coating method, or the like can also be used.

Next, in drying step A4, the metal oxide paste film is dried. In firing step A5, primary film 91 formed in primary film deposition step A2 and the metal oxide paste film dried in drying step A4 are heated and fired at a temperature of several hundred degrees. In this firing step A5, the solvent and the resin component remaining in the metal oxide paste film are removed, so that protective layer 9 with aggregated particles 92 of the magnesium oxide (MgO) crystals attached onto primary film 91 can be formed.

These metal oxide paste film forming step A3, drying step A4 and firing step A5 are steps for forming the aggregated particles of the metal oxide particles.

In addition, although magnesium oxide (MgO) is taken as an example as primary film 91 in the above description, primary film 91 is required to have high sputtering withstanding performance for protecting dielectric layer 8 from ion impact, and may not necessarily have high electric charge retention capability, or high electron emission performance.

In a conventional PDP, there has often been the case of forming a protective layer chiefly made of magnesium oxide (MgO) in order to satisfy both the electron emission performance and the sputtering withstanding performance above a certain level. However, in the present invention, aggregated particles 92 of the metal oxide crystals chiefly control the electron emission performance. For this reason, primary film 91 is not at all necessarily magnesium oxide (MgO), and another material more excellent in sputtering withstanding performance, such as aluminum oxide (Al₂O₃), may be used without any problem.

Further, although aggregated particles 92 of magnesium oxide (MgO) crystals are used as aggregated particles 92 of the metal oxide crystals in the foregoing description, aggregated particles of another metal oxide particles may also be used. Moreover, also with use of aggregated particles made of a metal oxide having high electro emission performance as with magnesium oxide (MgO), such as a metal oxide of strontium (Sr), calcium (Ca), barium (Ba), or aluminum (Al), a similar effect can be obtained. Hence the kind of the aggregated particles is not particularly restricted to magnesium oxide (MgO).

The foregoing steps allow forming scan electrodes 4, sustain electrodes 5, light proof layer 7, dielectric layer 8, primary film 91, and aggregated particles 92 of magnesium oxide crystals, on front glass substrate 3.

In the meantime, rear panel 10 is formed as follows. First, a metal film is formed on the entire surface of rear glass substrate 11 with a method for screen-printing a past containing a silver (Ag) material onto rear glass substrate 11, or some other method. Thereafter, with a method for patterning by means of the photolithography method, or the like, a material layer (not shown) to be a constituent for address electrodes 12 is formed, which is then fired at a predetermined temperature, to form address electrodes 12. A dielectric paste is then applied onto rear glass substrate 11, formed with address electrodes 12, with the die-coating method or the like so as to cover address electrodes 12, thereby forming a dielectric paste layer (not shown). The dielectric paste layer is then fired, to form primary dielectric layer 13. It should be noted that the dielectric paste is a paint containing binder, solvent, and a dielectric material such as glass powder.

A paste for barrier rib formation, containing a material for barrier ribs, is then applied onto primary dielectric layer 13, and patterned into a predetermined shape, to form a barrier rib material layer, which is then fired to form barrier ribs 14. Here, as a method for patterning the paste for barrier rib formation applied onto primary dielectric layer 13, the photolithography method or a sand-blasting method can be employed. Subsequently, a phosphor paste containing a phosphor material is applied onto primary dielectric layer 13 between adjacent barrier ribs 14 and side surfaces of barrier ribs 14, and then fired, to form phosphor layer 15. The foregoing steps allow completely forming rear panel 10, having the predetermined structural elements, on rear glass substrate 11.

In this manner, front panel 2 and rear panel 10, provided with the predetermined structural elements, are opposed to each other such that scan electrodes 4 intersect at right angles with address electrodes 12, the peripheries of front panel 2 and rear panel 10 are sealed with glass frit, and discharge space 16 is filled with discharge gas containing Neon (Ne), Xenon (Xe), and the like, to completely form PDP 1.

Next described is the metal oxide paste for forming the layer attached with aggregated particles 92 of the metal oxide particles onto primary film 91 in metal oxide paste film forming step A3 of the method for manufacturing PDP 1 in the present invention. In particular, results of experiments conducted for verifying a mass-production stability effect of the metal oxide paste are described. Types of chemicals used, as well as conditions of numerical values such as amounts of those chemicals, given in the following description are merely exemplary, and the present invention is not restricted thereto.

The metal oxide paste for forming the layer attached with the aggregated particles of the metal oxide particles are prepared in accordance with compositions shown in Table 1.

### [Table 1]

Composition Nos. 101 to 106 are formed as follows: a powder of aggregated particles of magnesium oxide (MgO) crystals (0.2 vol %) is used as the metal oxide, and butyl carbitol (68.93 vol % to 57.84 vol %) and terpineol (23.66 vol % to 19.85 vol %) are used as the diluting solvent. Further, ethyl cellulose (available from Nisshin Kasei Co., Ltd.) having a viscosity of a molecular weight grade of 4 cP (7.21 vol % to 22. 11 vol %) is used as the organic resin component. The metal oxide powder, butyl carbitol, terpineol, and ethyl cellulose are dispersed and mixed uniformly with a three-roll mill, to prepare a metal oxide paste.

Composition Nos. 107 to 111 are formed as follows: butyl carbitol (68.93 vol % to 63.01 vol %) and terpineol (23.66 vol % to 21.63 vol %) are used as the diluting solvent. Ethyl cellulose having a viscosity of a molecular weight grade of 10 cP (7.21 vol % to 15.16 vol %) is used as the organic resin component. The other material used is the same as in Composition Nos. 101 to 106.

Composition Nos. 112 to 116 are formed as follows: butyl carbitol (71.32 vol % to 66.88 vol %) and terpineol (24.48 vol % to 22.96 vol %) are used as the diluting solvent. Ethyl cellulose having a viscosity of a molecular weight grade of 100 cP (4.00 vol % to 9.96 vol %) is used as the organic resin component. The other material used is the same as in Composition Nos. 101 to 106.

Composition Nos. 117 to 122 are formed as follows: butyl carbitol (71.46 vol % to 66.88 vol %) and terpineol (24.53 vol % to 22.96 vol %) are used as the diluting solvent. Ethyl cellulose having a viscosity of a molecular weight grade of 200 cP (3.81 vol % to 9.96 vol %) is used as the organic resin component. The other material used is the same as in Composition Nos. 101 to 106.

It is to be noted that, although ethyl cellulose is used as the organic resin component listed in Table 1, other than that, a cellulose derivative such as hydroxypropyl cellulose, hydroxyethyl cellulose, hydroxypropyl methylcellulose phtalate, or hydroxypropyl methylcellulose acetate can also be used.

Further, although diethylene glycol monobutyl ether (butyl carbitol) and terpineol are used as the diluting solvent listed in Table 1, other than those, the following can also be used singly or in combination of two or more of them: ethylene glycol mono-methyl ether, ethylene glycol mono-ethyl ether, propylene glycol mono-methyl ether, propylene glycol mono-ethyl ether, diethylene glycol mono-methyl ether, diethylene glycol mono-ethyl ether, diethylene glycol dimethyl ether, diethylene glycol diethyl ether, propylene glycol mono-methyl ether acetate, propylene glycol mono-ethyl ether acetate, 2-methoxybutyl acetate, 3-methoxybutyl acetate, 4-methoxybutyl acetate, 2-methyl-3-methoxybutyl acetate, 3-methyl-3-methoxybutyl acetate, 3-ethyl-3-methoxybutyl acetate, 2-ethoxybutyl acetate, 4-ethoxybutyl acetate, 4-propoxybutyl acetate, 2-methoxypentyl acetate, or the like.

Moreover, according to need, a paste can be added with dioctyl phthalate, dibutyl phthalate, triphenyl phosphate, or tributyl phosphate as a plasticizer, and glycerop mono-oleate, sorbitan sesquio-leate, homogenol (product name by Kao Corporation), alkyl-allyl based phosphate or the like as a dispersant.

Verification is conducted on printability in application of the metal oxide paste prepared as described above onto front glass substrate 3 formed with scan electrodes 4, sustain electrodes 5, black stripe (light proof layer) 7, dielectric layer 8, and primary film 91, using the screen-printing method.

FIG. 4 is a characteristic diagram showing a viscosity value of the metal oxide paste in the embodiment of the present invention, showing a viscosity η with respect to an ethyl cellulose concentration (EC concentration) in the metal oxide paste. In verification of the printability, L380S mesh is employed as a screen plate. The viscosity η indicates a viscosity value at a shear rate of D=1 (1/s) with use of Reo-Stress RS600 (manufactured by Hakke Co., Ltd.). The printability is verified by observing knocking in printing. In FIG. 4, conditions on which knocking occurs are each plotted with a solid point, and conditions on which knocking does not occur are each plotted with an open point.

The knocking in this context means that in the screen-printing, a squeegee does not smoothly operate but vertically quivers on a screen plate as if getting snagged thereon.

As seen from FIG. 4, occurrence of the knocking does not depend upon a viscosity value of ethyl cellulose based upon a molecular weight grade, but the knocking occurs when a content of ethyl cellulose in the metal oxide paste is smaller than 8.0 vol %. This shows dependency of frictional resistance between the screen plate and the squeegee in the screen-printing upon a content of the organic resin component in the paste rather than upon the paste viscosity. It should be noted that as the dielectric paste or the like, one with a content of the organic resin component being the order of 5% is used, and this is considered because a content of an inorganic component that is typified by the metal oxide contained in the paste is not smaller than 1.5 vol %, thereby alleviating the frictional resistance between the screen plate and the squeegee.

Further, a coverage of aggregated particles 92 with respect to a substrate where the knocking has occurred is measured, to find an internal surface variation not smaller than about 10%, and hence aggregated particles 92 of the magnesium oxide (MgO) crystals cannot be uniformly formed over the entire surface. On the other hand, a coverage of aggregated particles 92 with respect to a substrate where the knocking has not occurred is measured, to find an internal surface variation within about 6%, and hence aggregated particles 92 can be formed uniformly over the entire surface.

It should be noted that the “internal surface variation” in this context refers to a value obtained by calculating a standard deviation a and an average value M of a coverage obtained with the foregoing coverage measuring method on each of 54 points inside the substrate surface, and dividing σ by the average value. In other words, this is expressed by: internal surface variation=σ/M×100(%).

It is found from the above that in order for a paste with a content of metal oxide particles being not larger than 1.5 vol % to have favorable printability without occurrence of the knocking, a content of the organic resin component needs to be not smaller than 8.0 vol %.

Meanwhile, in the manufacturing steps for forming protective layer 9 in FIG. 3 in accordance with the present invention, after metal oxide paste film forming step A3 and drying step A4, the organic component contained in the past needs to be removed by firing step A5. Further, when the content of the organic resin component in the paste increases, firing residues increase by an amount corresponding to the increased content. This leads to introduction of an organic matter into a PDP after completely formed, to have an adverse effect upon panel discharge characteristics. As a result of repeated experiments and studies, the present inventors found that the adverse effect upon the panel discharge characteristics can be eliminated when the content of the organic resin component in the paste is not larger than 20 vol %.

As described above employed is a metal oxide paste containing the aggregated particles of the metal oxide particles, the organic resin component and the diluting solvent, with a content of the aggregated particles of the metal oxide particles being not larger than 1.5 vol % and a content of the organic resin component being 8.0 vol % to 20.0 vol %. It is thereby possible to provide a paste suitable for the printability and capable of preventing deterioration in discharge characteristics due to residues of the organic resin component.

It should be noted that, as described above, in PDP 1 in the embodiment of the present invention, the coverage of aggregated particles 92 of the magnesium oxide (MgO) crystals is desirably in the range of 2% to 12% in view of discharge characteristics of PDP 1. Since the coverage is determined at this time based upon a film thickness of the metal oxide paste film, a content of aggregated particles 92 in the metal oxide paste is preferably in a range of 0.01 vol % to 1.5 vol % based upon a film thickness range of a film formable by the screen-printing.

Next described is a result of studies of the organic resin component in the metal oxide paste for screen-printing used in the present invention. It is to be noted that types of chemicals used, as well as conditions of numerical values such as amounts of those chemicals, given in the following description are merely exemplary, and the present invention is not restricted thereto.

The metal oxide paste for forming the layer attached with the aggregated particles of the metal oxide particles are prepared in accordance with compositions shown in Table 2.

### [Table 2]

Composition No. 201 is formed as follows: a powder of aggregated particles of magnesium oxide (MgO) crystals (0.2 vol %) is used as the metal oxide, and butyl carbitol (66.8 vol %) and terpineol (23.0 vol %) are used as the diluting solvent. Further, ethyl cellulose (10.0 vol %) is used as the organic resin component. The metal oxide powder, butyl carbitol, terpineol, and ethyl cellulose are dispersed and mixed uniformly with a three-roll mill, to prepare a metal oxide paste.

Composition No. 202 is formed using hydroxypropyl cellulose (10.0 vol %) as the organic resin component. The other materials are the same as in Composition No. 201.

Composition No. 203 is formed using hydroxypropylmethyl cellulose acetate phtalate (10.0 vol %) as the organic resin component. The other materials are the same as in Composition No. 201.

It is to be noted that, although ethyl cellulose (EC), hydroxypropyl cellulose (HPC), and hydroxypropylmethyl cellulose acetate phtalate (HPMCAP) are used as the organic resin components listed in Table 2, other than those, another cellulose derivative such as hydroxyethyl cellulose or hydroxypropyl methylcellulose acetate can also be used.

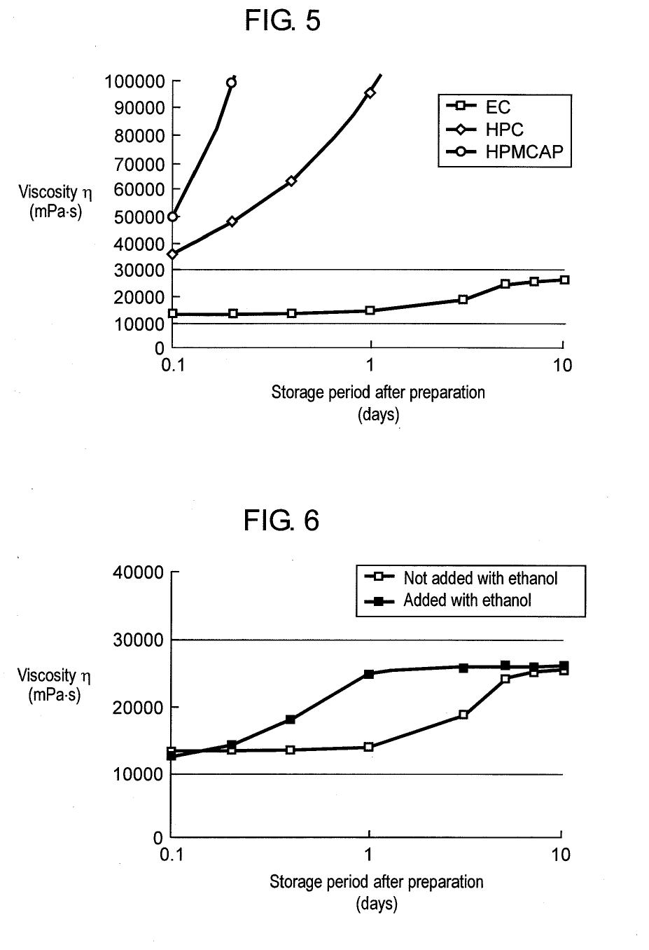

FIG. 5 is a characteristic diagram showing a relation between a storage period and a viscosity η (D=1s⁻¹) after preparation of the metal oxide paste in the embodiment of the present invention, and in FIG. 5, an area with a viscosity η of 10000 to 30000 mPa·s indicates a viscosity range in which printing can be performed with the screen-printing method.

As seen from FIG. 5, as compared with the paste containing hydroxypropyl cellulose (HPC) and the paste containing hydroxypropylmethyl cellulose acetate phtalate (HPMCAP) as the organic resin component, the paste containing ethyl cellulose (EC) as the organic resin component has a stable viscosity also after preparation of the paste, and even when the printability is actually verified on a first day after the preparation, no problem is observed.

On the other hand, as for each of hydroxypropyl cellulose (HPC) and hydroxypropylmethyl cellulose acetate phtalate (HPMCAP), the viscosity rises immediately after preparation of the paste, and in verification of the printability, it is found that a metal oxide layer cannot be formed over the entire surface and is thus not suitable for pasting for screen-printing.

Here, ethyl cellulose (EC) is resistant to thickening and gelation as compared with hydroxypropyl cellulose (HPC) and hydroxypropylmethyl cellulose acetate phtalate (HPMCAP). This is because, as compared with hydroxypropyl cellulose (HPC) and hydroxypropylmethyl cellulose acetate phtalate (HPMCAP), ethyl cellulose (EC) contains relatively small amounts of a hydroxyl group and a carboxyl group, and even when the aggregated particles of the metal oxide particles are added, ions eluted from such aggregated particles and the hydroxyl group and the carboxyl group of the organic resin compounds are not apt to form a three-dimensional network by ion-crosslinking.

As described above, in a metal oxide paste with a content of the aggregated particles of the metal oxide particles being not larger than 1.5 vol %, a content of the organic resin component is in the range of 8.0 to 20.0 vol % and the organic resin component contains ethyl cellulose (EC), so that a metal oxide paste suitable for the printability can be provided.

Next described is a result of the case of adding a viscosity stabilizer containing a hydroxyl group in the metal oxide paste for screen-printing used in the present invention. It is to be noted that types of chemicals used, as well as conditions of numerical values such as amounts of those chemicals, given in the following description are merely exemplary, and the present invention is not restricted thereto.

The metal oxide paste for forming the layer attached with the aggregated particles of the metal oxide particles are prepared in accordance with compositions shown in Table 3.

### [Table 3]

Composition No. 301 is formed as follows: a powder of aggregated particles of magnesium oxide (MgO) crystals (0.2 vol %) is used as the metal oxide, and butyl carbitol (66.8 vol %) and terpineol (23.0 vol %) are used as the diluting solvent. Further, ethyl cellulose (10.0 vol %) is used as the organic resin component. The metal oxide powder, butyl carbitol, terpineol, and ethyl cellulose are dispersed and mixed uniformly with a three-roll mill, to prepare a metal oxide paste.

Composition No. 302 is formed using butyl carbitol (66.5 vol %) and terpineol (22.8 vol %) as the diluting solvent. Further, ethyl alcohol (0.5 vol %) is added as the viscosity stabilizer. The other materials are the same as in Composition No. 301.

FIG. 6 is a characteristic diagram showing a relation between a storage period and a viscosity η (D=1s⁻¹) after preparation of the metal oxide paste in the embodiment of the present invention. In FIG. 6, an area with a viscosity η of 10000 to 30000 mPa·s indicates a viscosity range in which printing can be performed with the screen-printing method as in FIG. 5.

As seen from FIG. 6, as compared with the paste not added with ethanol, the paste added with ethanol as the viscosity stabilizer has viscosity stabilized immediately after preparation of the paste, and even in verification of the printability on each of a first day, a third day, a fifth day, and tenth day after preparation of the paste, any problem is observed.

On the other hand, since the viscosity of the paste not added with the viscosity stabilizers rises gradually after preparation of the paste, in verification of the printability, it is found that separability from the plate becomes worse gradually on the first day, the third day, and the fifth day after preparation of the paste, causing a significant change in film thickness as well as coverage.

Specifically, in the paste not added with the viscosity stabilizer, due to a hydroxyl group contained in a minute amount in the paste such as solvent, after preparation of the paste, a three-dimensional network is formed by ion-crosslinking with ions gradually eluted from the aggregated particles of the metal oxide particles, causing an increase in viscosity. As opposed to this, in the paste added with the viscosity stabilizer containing a hydroxyl group, the hydroxyl group of the added stabilizer and ions eluted from the metal oxide powder are forcefully ion-crosslinked, to prevent an increase in viscosity with elapsed time, resulting in improvement in stability of the viscosity.

As described above, in a metal oxide paste with a content of the aggregated particles of the metal oxide particles being not larger than 1.5 vol %, a content of the organic resin component is in the range of 8.0 vol % to 20.0 vol %, ethyl cellulose is contained in the organic resin component, and the viscosity stabilizer containing a hydroxyl group is further added, so that a metal oxide paste further suitable for the printability can be provided.

Next described are results of experiments conducted for verifying an effect of the PDP in the embodiment of the present invention.

First, samples of PDPs having protective layers with different configurations are made. Sample 1 is a PDP formed with a protective layer made only of a magnesium oxide (MgO) film, Sample 2 is a PDP formed with a protective layer made only of magnesium oxide (MgO) doped with an impurity such as aluminum (Al) or silicon (Si), and Sample 3 is the PDP in accordance with the present invention in which aggregated particles of the metal oxide particles are attached onto the primary film made of magnesium oxide (MgO) so as to be distributed almost uniformly over the entire surface.

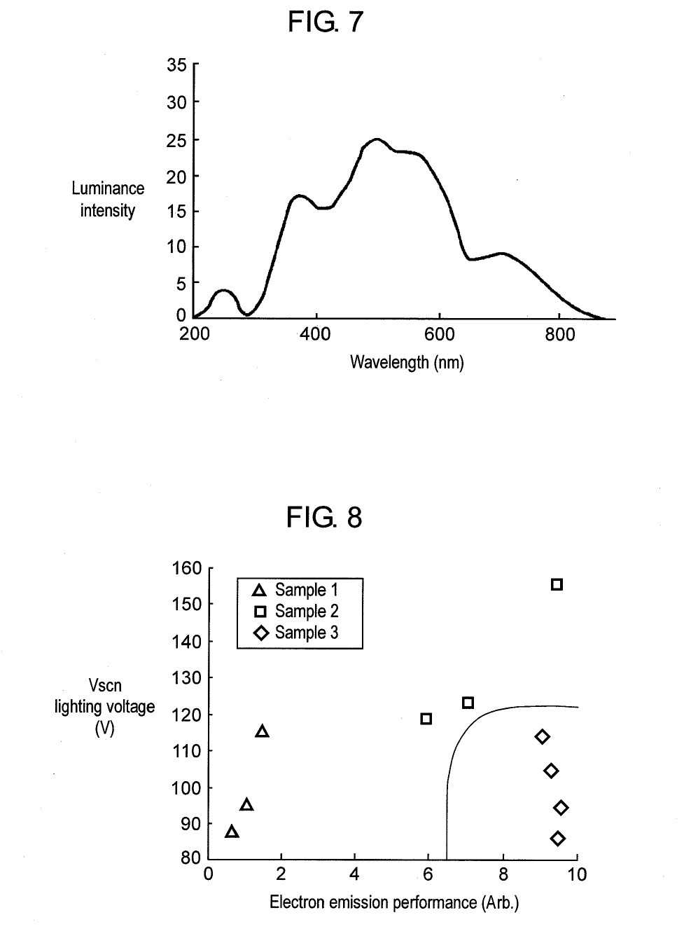

FIG. 7 is a diagram showing a result of a cathode luminescence measurement. In Sample 3, aggregated particles of magnesium oxide (MgO) crystals are used as the aggregated particles of the metal oxide particles, and cathode luminance is measured, to find Sample 3 having characteristics as shown in FIG. 7.

These PDPs respectively having the protective layers of three kinds of configurations are studied for the electron emission performance and electric charge retention performance thereof.

It is to be noted that the electron emission performance is a numerical value that indicates a larger amount of electrons emitted when being a larger value, and is expressed by means of an amount of primary electrons emitted, which is determined based upon a surface condition and a type and a state of gas in discharge. Although, the amount of primary electrons emitted can be measured with a method for measuring an amount of an electron-current emitted from the surface through irradiation of the surface with ions or an electron beam, it is difficult to evaluate the surface of the front panel without breakage therein. Therefore, as described in Unexamined Japanese Patent Publication No. 2007-48733, first, a numerical value as a guide of easiness of discharge occurrence, referred to as statistical delay time, is measured among delay time in discharge. Subsequently, an inverse value of the measured value is integrated, to give a numerical value linearly corresponding to the amount of primary electrons emitted, so that evaluation is performed here using this numerical value. This delay time in discharge means the time of a discharge delay which is a delay in discharge from rising of a pulse, and a main factor for the discharge delay is considered to be that the initial electrons to serve as a trigger at the start of discharge are resistant to emitting from the surface of the protective layer into the discharge space.

Further, as a reference of the electric charge retention performance, a voltage value of a voltage (hereinafter referred to as a Vscn lighting voltage) to be applied to scan electrodes is used, which is required for suppressing an electric charge emission phenomenon in the case of producing a PDP. In other words, higher electric charge retention performance is shown at a lower Vscn lighting voltage. This allows driving at a lower voltage also in panel designing for a PDP, so that a component with a smaller withstanding voltage and a smaller capacity can be employed as a power supply and each electric component. In currently existing products, an element having a withstanding voltage of the order of 150 V is employed as a semiconductor switching element such as a metal-oxide semiconductor field-effect transistor (MOSFET) for sequentially applying a scan voltage to a panel, and the Vscn lighting voltage is preferably suppressed to not larger than 120 V in consideration of variations due to a temperature.

FIG. 8 is a characteristic diagram showing a result of a study on the electron emission performance and a Vscn lighting voltage in the PDP, a study on the electron emission performance and electric charge retention performance.

In Sample 3 where aggregated particles 92 of the magnesium oxide (MgO) crystals are formed on primary film 91 of magnesium oxide (MgO) so as to be almost uniformly distributed over the entire surface, the Vscn lighting voltage can be set to not larger than 120 V in evaluation of the electric charge retention. Furthermore, as for the electron emission performance, a favorable characteristic of not smaller than 6 can be obtained.

In other words, in general, the electron emission capability and the electric charge retention capability of a protective layer of a PDP conflict with each other. For instance, changing a film forming condition for the protective layer or doping an impurity such as aluminum (Al), silicon (Si), or barium (Ba) into the protective layer to form a film can improve the electron emission performance, but the Vscn lighting voltage also rises as a side effect.

According to the present invention, it is possible to form a protective layer that can satisfy both the electron emission capability and the electric charge retention capability for a PDP having tendencies to be increased in number of scanning lines and reduced in cell size with the progress of high definition.

Next, a particle diameter of aggregated particles 92 used in Sample 3 is described. It is to be noted that in the following description, the particle diameter means an average particle diameter, and the average particle diameter means a volume cumulative average diameter (D50).

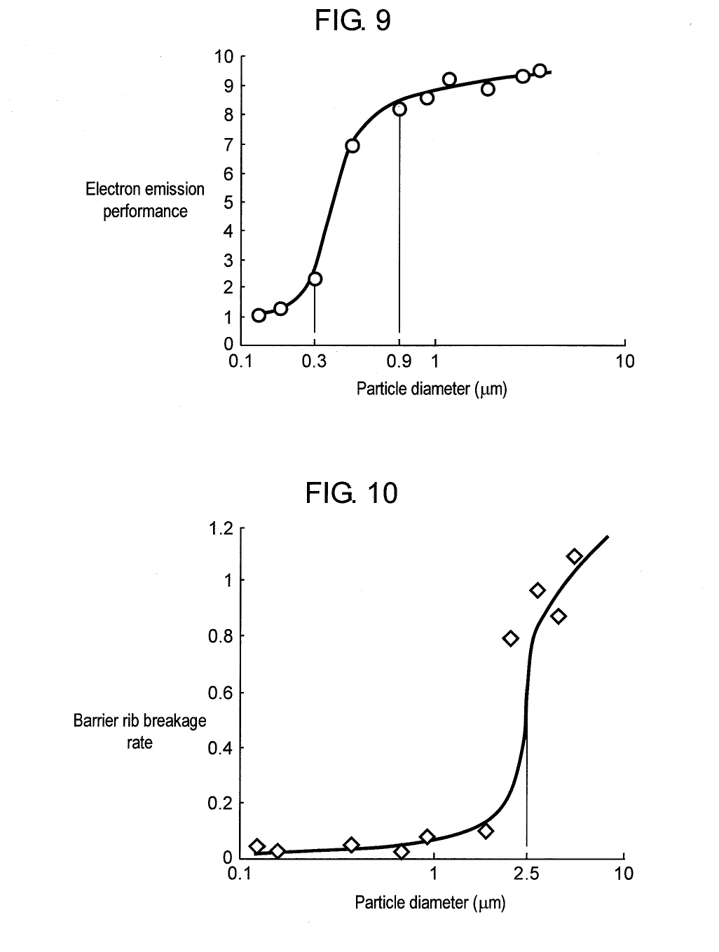

FIG. 9 is a characteristic diagram showing a relation between a particle diameter of the aggregated particles and the electron emission characteristics. FIG. 9 shows a result of an experiment in which, in Sample 3 of the present invention described in FIG. 8 above, a particle diameter of aggregated particles 92 of the magnesium oxide (MgO) crystals is changed, to study the electron emission performance. It should be noted that in FIG. 9, the particle diameter of aggregated particles 92 indicates an average particle diameter obtained in measurement of a particle size distribution in an ethanol solution of a first grade reagent or higher with a micro-track HRA particle-size distribution meter, and further, the particle diameter is measured by SEM (scanning electron microscope) observation of aggregated particles 92.

As shown in FIG. 9, it is found that the electron emission performance is lower when the particle diameter is smaller to the order of 0.3 μm, and is higher when the particle diameter is almost not smaller than 0.9 μm.

Incidentally, in order to increase the number of electrons emitted inside the discharge cell, the number of aggregated particles per unit area on the protective layer is desirably larger. On the other hand, the experiment conducted by the present inventors reveals that in the presence of aggregated particles 92 in a portion corresponding to the top of the barrier rib of the rear panel closely in contact with the protective layer of the front panel, the top of the barrier rib breaks and its material falls on the phosphor layer, leading to occurrence of a phenomenon that the corresponding cell is not normally turned on and off. Since this phenomenon of breakage in barrier rib is not apt to occur unless aggregated particles 92 are present in the portion corresponding to the top of the barrier rib, the probability of occurrence of the breakage in barrier rib becomes higher with increase in number of aggregated particles to be attached.

FIG. 10 is a characteristic diagram showing a relation between the particle diameter of the aggregated particles and the rate of occurrence of breakage in barrier rib. FIG. 10 shows a result of an experiment in which in Sample 3 in accordance with the present invention described in FIG. 8 above, the same number of aggregated particles 92 with different particle diameters per unit area are dispersed, to study the relation of breakage in barrier rib. As apparent from this FIG. 8, the probability of breakage in barrier rib sharply increases when the diameter of the crystal particle becomes larger to the order of 2.5 μm, whereas the probability of breakage in barrier rib can be relatively held small when the particle diameter is smaller than 2.5 μm. Based upon the above result, as aggregated particles 92, one having a diameter of not smaller than 0.9 μm and not larger than 2.5 μm is desired in the protective layer in the method for manufacturing a PDP of the present invention, but when PDPs are to be actually mass-produced, it is necessary to consider a variation in aggregated particles 92 in manufacturing and a variation in the case of protective layers in manufacturing.

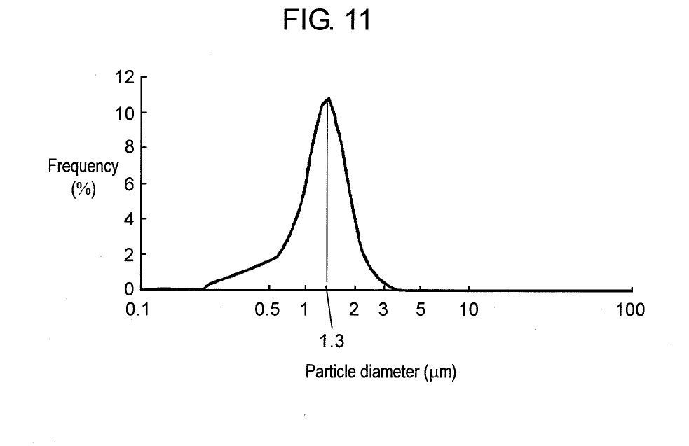

FIG. 11 is a characteristic diagram showing an example of the aggregated particles and a particle size distribution. In order to consider a factor for the variation in manufacturing as described above and the like, experiments are conducted using aggregated particles with different particle diameter distributions, and it is consequently found that as shown in FIG. 11, the use of aggregated particles 92 having an average particle diameter in the range of 0.9 μm to 2 μm can stably give the forgoing effect of the present invention.

As thus described, in the PDP having the protective layer formed using the metal oxide paste for screen-printing in accordance with the present invention, the electron emission capability is a characteristic of not smaller than six, and the electric charge retention capability is a Vscn lighting voltage of not larger than 120 V. Accordingly, as the protective layer of the PDP having tendencies to be increased in number of scanning lines and reduced in cell size with the progress of high definition, it is possible to satisfy both the electron emission capability and the electric charge retention capability, thereby to realize a PDP with high-definition/high-luminance display performance as well as with low power consumption.

Incidentally, in the PDP in the present invention, as described above, aggregated particles 92 of the magnesium oxide (MgO) crystals are attached so as to be distributed at a coverage in the range of 2% to 12% over the entire surface. This derives from results of the studies conducted by the present inventors by making the samples with changed coverage of aggregated particles 92 to study characteristics of the samples. In other words, it is found that the Vscn lighting voltage becomes larger and worse with increase in coverage of aggregated particles 92, whereas the Vscn lighting voltage becomes smaller with decrease in coverage.

Repeated experiments and studies based upon these results lead to finding that the coverage of aggregated particles 92 is preferably not larger than 12% for sufficiently exerting the effect by attachment of aggregated particles 92 as described above.

Meanwhile, reducing a variation in panel discharge characteristics requires the presence of aggregated particles 92 of the magnesium oxide (MgO) crystals in each discharge cell, which requires aggregated particles 92 to be attached onto primary film 91 so as to be distributed almost uniformly over the entire surface. However, it is found that a variation in coverage within the surface tends to become larger in the case of the coverage being smaller, thus resulting in a larger variation in aggregated particles 92 in an attached state between the discharge cells. It is found from the result of the experiments conducted by the present inventors that attaching particles 92 so as to have a coverage of not smaller than 4% can suppress the internal surface variation at not larger than about 4%. Further, it is found that also in the case of attaching aggregated particles 92 so as to have a coverage of not smaller than 2%, the internal surface variation can be suppressed at the order of about 6%, which practically causes no problem.

In accordance with these results, in the present invention, it is desirable to attach aggregated particles 92 so as to have a coverage in the range of 2% to 12%, and further desirable to attach aggregated particles 92 so as to have a coverage in the range of 4% to 12%.

### INDUSTRIAL APPLICABILITY

As thus described, the present invention is useful in realization of a PDP with high-definition/high-luminance display performance as well as with low power consumption.

### REFERENCE MARKS IN THE DRAWINGS

1 PDP
2 front panel
3 front glass substrate
4 scan electrode
4a, 5a transparent electrode
4b, 5b metal bus electrode
5 sustain electrode
6 display electrode
7 black stripe (light proof layer)
8 dielectric layer
9 protective layer
10 rear panel
11 rear glass substrate
12 address electrode
13 primary dielectric layer
14 barrier rib
15 phosphor layer
16 discharge space
81 first dielectric layer
82 second dielectric layer
91 primary film
92 aggregated particle

TABLE 1

| | | COMPOSITION NO. | | | | | | | | | | |
|---|---|---|---|---|---|---|---|---|---|---|---|---|
| | | 101 | 102 | 103 | 104 | 105 | 106 | 107 | 108 | 109 | 110 | 111 |
| METAL | MgO POWDER | 0.20 | 0.20 | 0.20 | 0.20 | 0.20 | 0.20 | 0.20 | 0.20 | 0.20 | 0.20 | 0.20 |
| OXIDE | | | | | | | | | | | | |
| ORGANIC | ETHYL CELLULOSE | 7.21 | 8.64 | 9.96 | 14.76 | 17.09 | 22.11 | — | — | — | — | — |
| RESIN | (4 cP) | | | | | | | | | | | |
| COMPONENT | ETHYL CELLULOSE (10 | — | — | — | — | — | — | 7.21 | 8.64 | 9.46 | 12.47 | 15.16 |
| | cP) | | | | | | | | | | | |
| DILUTING | BUTYL CARBITOL | 68.93 | 67.86 | 66.88 | 63.31 | 61.57 | 57.84 | 68.93 | 67.86 | 67.25 | 65.01 | 63.01 |
| SOLVENT | TERPINEOL | 23.66 | 23.30 | 22.96 | 21.73 | 21.14 | 19.85 | 23.66 | 23.30 | 23.09 | 23.32 | 21.63 |
| TOTAL | | 100.00 | 100.00 | 100.00 | 100.00 | 100.00 | 100.00 | 100.00 | 100.00 | 100.00 | 100.00 | 100.00 |
| | | COMPOSITION NO. | | | | | | | | | | |
| | | 112 | 113 | 114 | 115 | 116 | 117 | 118 | 119 | 120 | 121 | 122 |
| METAL | MgO POWDER | 0.20 | 0.20 | 0.20 | 0.20 | 0.20 | 0.20 | 0.20 | 0.20 | 0.20 | 0.20 | 0.20 |
| OXIDE | | | | | | | | | | | | |
| ORGANIC | ETHYL CELLULOSE | 4.00 | 5.41 | 7.21 | 8.64 | 9.96 | — | — | — | — | — | — |
| RESIN | (100 cP) | | | | | | | | | | | |
| COMPONENT | ETHYL CELLULOSE | — | — | — | — | — | 3.81 | 5.15 | 6.31 | 7.21 | 8.64 | 9.96 |
| | (200 cP) | | | | | | | | | | | |
| DILUTING | BUTYL CARBITOL | 71.32 | 70.27 | 68.93 | 67.86 | 66.88 | 71.46 | 70.46 | 69.60 | 68.93 | 67.86 | 66.88 |
| SOLVENT | TERPINEOL | 24.48 | 24.12 | 23.66 | 23.30 | 22.96 | 24.53 | 24.19 | 23.89 | 23.66 | 23.30 | 22.96 |

| | | | | | | | | | | | |
|---|---|---|---|---|---|---|---|---|---|---|---|
| TOTAL | 100.00 | 100.00 | 100.00 | 100.00 | 100.00 | 100.00 | 100.00 | 100.00 | 100.00 | 100.00 | 100.00 |

*In table, numerical value unit is vol %

TABLE 2

| | COMPOSITION NO. | 201 | 202 | 203 |
|---|---|---|---|---|
| METAL | MgO POWDER | 0.2 | 0.2 | 0.2 |
| OXIDE | | | | |
| ORGANIC | ETHYL CELLULOSE (EC) | 10.0 | — | — |
| RESIN | HYDROXYPROPYL | — | 10.0 | — |
| COMPONENT | CELLULOSE (HPC) | | | |
| | HYDROXYPROPYLMETHYL | — | — | 10.0 |
| | CELLULOSE ACETATE | | | |
| | PHTALATE (HPMCAP) | | | |
| DILUTING | BUTYL CARBITOL | 66.8 | 66.8 | 66.8 |
| AGENT | TERPINEOL | 23.0 | 23.0 | 23.0 |

| | | | |
|---|---|---|---|
| TOTAL | 100.0 | 100.0 | 100.0 |

TABLE 3

| | COMPOSITION NO. | 301 | 302 |
|---|---|---|---|
| METAL OXIDE | MgO POWDER | 0.2 | 0.2 |
| ORGANIC RESIN | ETHYL CELLULOSE (EC) | 10.0 | 10.0 |
| COMPONENT | | | |
| DILUTING | BUTYL CARBITOL | 66.8 | 66.5 |
| AGENT | TERPINEOL | 23.0 | 22.8 |
| VISCOSITY | ETHYL ALCOHOL | — | 0.5 |
| STABILIZER | | | |

| | | |
|---|---|---|
| TOTAL | 100.0 | 100.0 |

* IN TABLE, NUMERICAL VALUE UNIT IS vol %

1. A method for manufacturing a plasma display panel, the plasma display panel having:
a front panel including:
a dielectric layer so as to cover a display electrode formed on a substrate; and
a protective layer on the dielectric layer, and
a rear panel facing the front panel so as to form a discharge space and including:
an address electrode in a direction intersecting with the display electrode; and
a barrier rib partitioning the discharge space,
the method comprising:
a step of forming a protective layer, which forms the protective layer of the front panel,
wherein the step of forming a protective layer includes:
a step of forming a primary film, which forms a primary film on the dielectric layer by depositing; and
a step of forming aggregated particles of metal oxide particles, which applies to the primary film a metal oxide paste containing aggregated particles of metal oxide particles, an organic resin component, and diluting solvent, and
then fires the metal oxide paste, to attach the aggregated particles of the metal oxide particles to the primary film, and
wherein in the step of forming aggregated particles, a metal oxide paste is used in which a content of the aggregated particles of the metal oxide particles is not larger than 1.5 vol %, the organic resin component contains ethyl cellulose, and a content of the organic resin component is in a range of 8.0 vol % to 20.0 vol %.

2. The method for manufacturing a plasma display panel according to claim 1, wherein a content of the aggregated particles of the metal oxide particles in the metal oxide paste is in a range of 0.01 vol % to 1.5 vol %.

3. The method for manufacturing a plasma display panel according to claim 1, wherein the metal oxide paste is applied by a screen-printing method.

4. The method for manufacturing a plasma display panel according to claim 1, wherein a viscosity stabilizer containing a hydroxyl group is added to the metal oxide paste.
